(19) United States
(12) Patent Application Publication
(10) Pub. No.: US 2007/0024764 A1
(43) Pub. Date: Feb. 1, 2007

(54) Methods and systems that compensate for distortion introduced by anamorphic lenses in a video projector

(75) Inventor: Yau Wing Chung, Fremont, CA (US)

Correspondence Address: MIN, HSIEH & HACK LLP, 8270 GREENSBORO DRIVE, SUITE 630, MCLEAN, VA, 22102, US

(73) Assignee: Optoma Technology, Inc.

(21) Appl. No.: 11/272,767

(22) Filed: Nov. 15, 2005

Related U.S. Application Data
(60) Provisional application No. 60/703,433, filed on Jul. 29, 2005.

(51) Int. Cl. H04N 3/22; H04N 3/26

(52) U.S. Cl. 348/745

(57) ABSTRACT

Anamorphic lenses within a video projector introduce distortion to the projected image due to the material makeup of the anamorphic lenses. The distortions can be identified and compensations can be determined. The compensations can be digitally applied to input video signals to reduce the distortion in the projected image.

### FIELD

Aspects of the present invention generally relate to video display methods and systems.

### BACKGROUND

Anamorphic lenses in a projection system introduce distortion into the projected image. Traditionally, distortion was minimized by constructing the anamorphic lenses from optical grade glass. However, lenses constructed of optical grade glass are very expensive. Acrylic/plastic anamorphic lenses are significantly less expensive, but acrylic/plastic anamorphic lenses introduce approximately five times more distortion than the optical grade glass lenses. Thus, there is a need for a system and method that compensates for the distortions introduced by anamorphic lenses, but also minimizes the cost associated with the lenses.

### SUMMARY

In accordance with one feature of the present invention, a method of correcting video distortion in a projection system is provided. An image is projected onto a viewing screen that is based on a predetermined image. Distortions present in the projected image are identified and a set of corrections that compensate for the identified distortions are determined. The projection system is then configured based on the set of corrections.

In accordance with another feature of the present invention, a system for displaying video is provided. An input is configured to receive a video signal. A set of lenses comprise at least one anamorphic lens that is configured to project the video signal. A memory device is configured to store a set of compensations for distortions present in the at least one anamorphic lens. A processor is then configured to modify the video signal based on the stored set of compensations.

Additional aspects of the present invention will be set forth in part in the description which follows, and in part will be obvious from the description, or may be learned by practice of the invention. The aspects of the present invention will be realized and attained by means of the elements and combinations particularly pointed out in the appended claims.

Further, it is to be understood that both the foregoing general description and the following detailed description are exemplary and explanatory only and are not restrictive of the present invention, as claimed.

### BRIEF DESCRIPTION OF THE DRAWINGS

The accompanying drawings, which are incorporated in and constitute a part of this specification, illustrate several aspects of the present invention and together with the description, serve to explain the principles of the invention.

FIG. 1 is a diagram illustrating a system for displaying a video consistent with aspects of the present invention;

FIG. 2 is a rear view diagram illustrating a system for displaying a video consistent with aspects of the present invention;

FIG. 3a is a diagram illustrating a DLP video projector consistent with aspects of the present invention;

FIGS. 3b-f are various views illustrating an integrated video projector and video source consistent with aspects of the present invention;

FIG. 3g is a diagram illustrating a DLP video projector consistent with aspects of the present invention;

FIG. 4 is a diagram of an exemplary arrangement of anamorphic lenses in a projection system.

FIG. 5a is a flow chart illustrating a method of calibrating a projection system consistent with aspects of the present invention.

FIG. 5b is a flow chart illustrating a method of applying compensations to a video input signal consistent with aspects of the present invention.

### DETAILED DESCRIPTION

Embodiments of the present invention provide systems and methods for compensating the distortion of anamorphic lenses in a display device, such as a projection system. Projection systems may utilize one or more anamorphic lenses to stretch a projected image into differing aspect ratios. Anamorphic lenses are typically composed of materials, such as optical grade glass or acrylic/plastic. In accordance with the principles of the present invention, the distortion of the anamorphic lenses in a projection system can be determined by comparing a known input image in a video signal with a resultant projected image. A set of digital compensations to the video signal may then be calculated to correct at least some of the distortion in the anamorphic lenses. In some embodiments, the set of digital compensations can be stored in a memory, such as an EEPROM or the like, and applied to video signals displayed by the projection system.

Reference will now be made in detail to various aspects of the present invention, examples of which are illustrated in the accompanying drawings. Wherever possible, the same reference numbers will be used throughout the drawings to refer to the same or like parts.

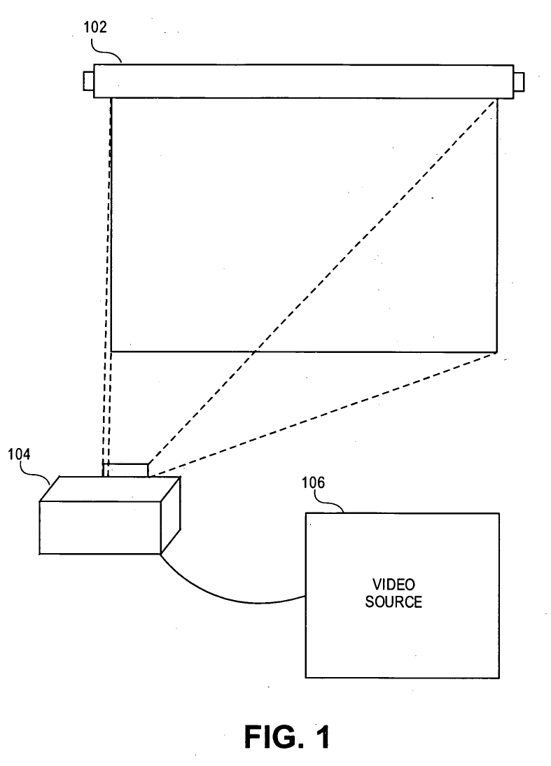

FIG. 1 illustrates a system 100 for displaying video consistent with aspects of the present invention. System 100 includes a display screen 102 for viewing video projected from a video projector 104. System 100 further includes a video source 106 which transmits a video signal to video projector 104. The video projected onto display screen 102 may be moving video or still images. Video projector 104 may be any type of video projector capable of receiving a video signal and converting the video signal to a viewable image to be displayed on display screen 102. For example, video projector 104 may be a digital light processing (“DLP”) video projector, a liquid crystal (“LCD”) video projector, or cathode-ray tube (“CRT”) projector.

As illustrated in FIG. 1, video source 106 supplies video projector 104 with a video signal to be displayed on video screen 102. Video source 106 may be any standard video equipment capable of generating a video signal readable by video projector 104. For example, video source 106 may be a Digital Versatile Disk (“DVD”) player, laser disk player, Compact Disk (“CD”) player, Video CD (“VCD”) player, VHS player/recorder, Digital Video Recorder (“DVR”), video camera, video still camera, cable receiver box, or satellite receiver box. Video source 106 may also be a standard laptop or desktop computer. One skilled in the art will realize that the preceding list of standard video equipment is exemplary and video source 106 may be any device capable of generating a video signal readable by video projector 104. Furthermore, video source 106 may be integrated with video projector 104. Additionally, video projector 104 may be coupled to multiple video sources 106.

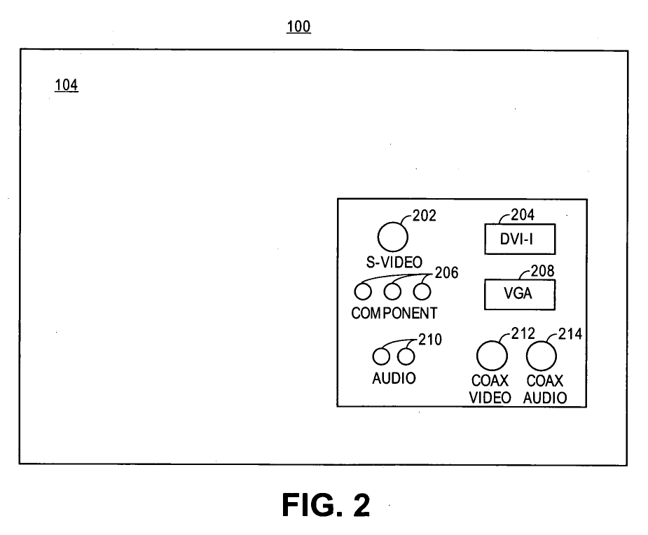

FIG. 2 is a back view of video projector 104 illustrating input/output ports 200 for sending and receiving signals consistent with aspects of the present invention. Video source 106 may be coupled to one of the input/output ports 200. As illustrated in FIG. 2, input/output ports 200 include an S-video input 202, DVI-I input 204, component video input 206, VGA input 208, audio input 210, coaxial video input 212, and coaxial audio input 214.

Input/output ports 200 may include additional input and output ports. For example, input/output ports 200 may include ports any number of a S-video input, S-video output, composite video input, composite video output, component video input, component video output, DVI-I video input, DVI-I video output, coaxial video input, coaxial video output, audio input, audio output, infrared input, infrared output, RS-232 input, RS-232 output, VGA input, or VGA output. One skilled in the art will realize that the preceding list of input and output ports is exemplary and that input/output ports 200 may include any port capable of sending or receiving an electrical signal. Input/output ports 200 are coupled to the internal components of video projector 104.

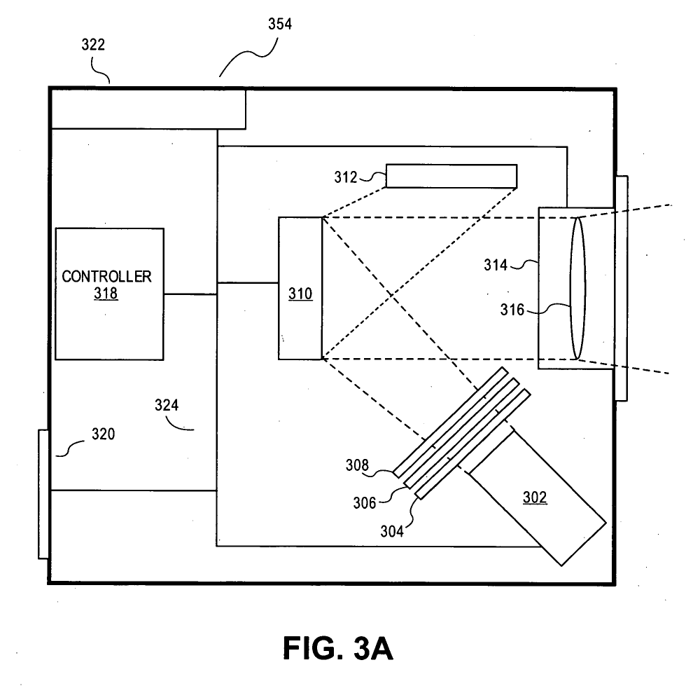

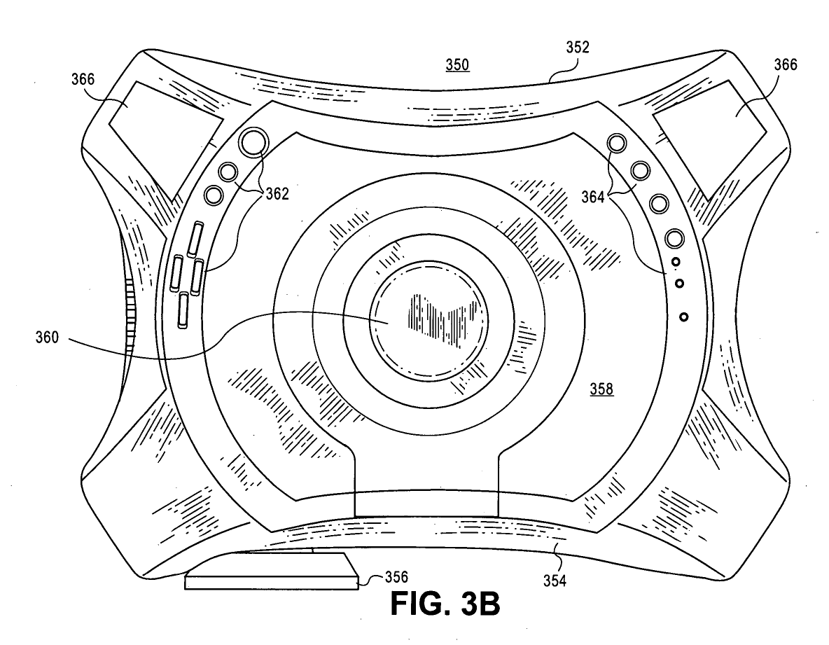

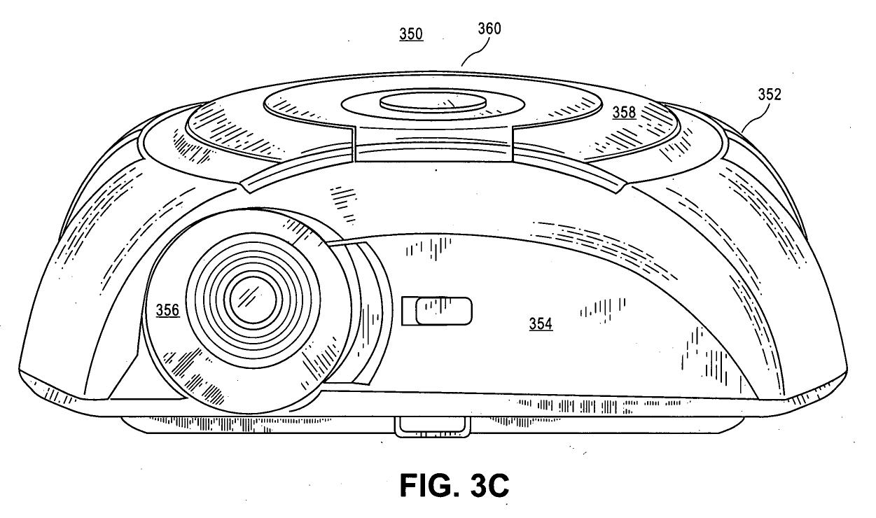

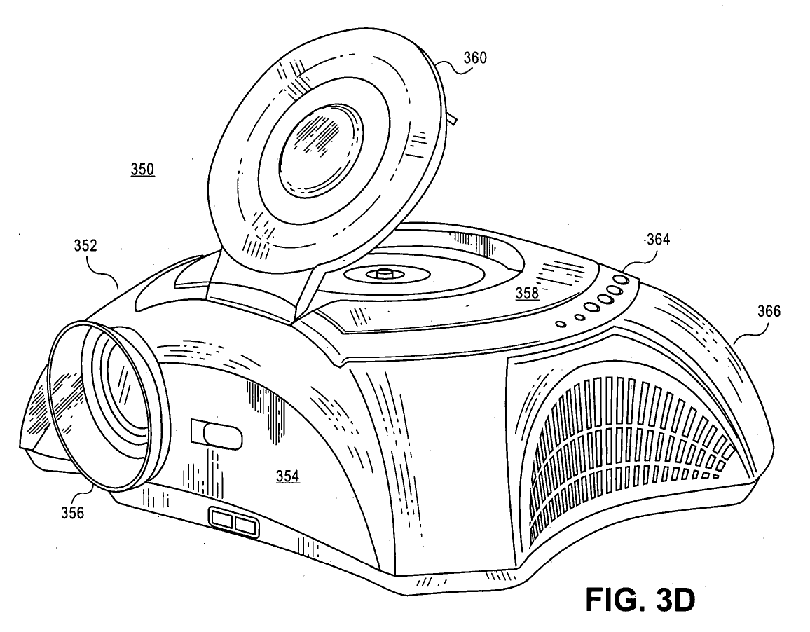

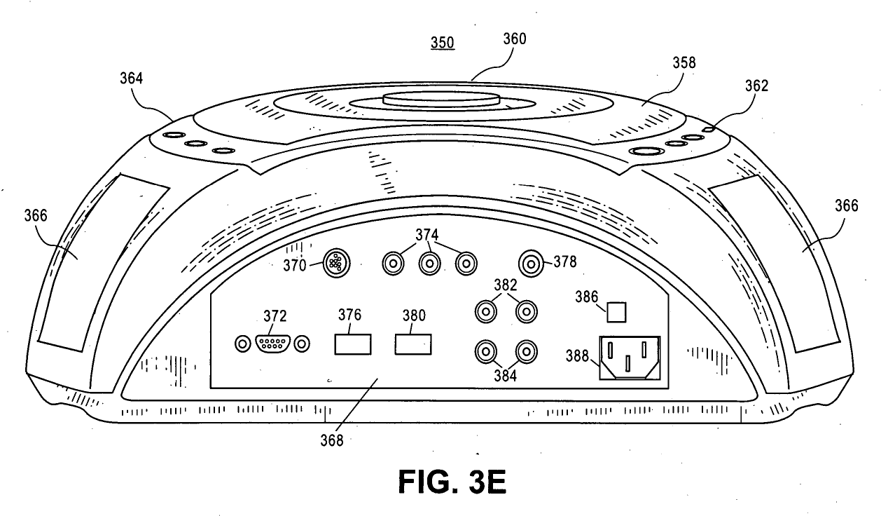

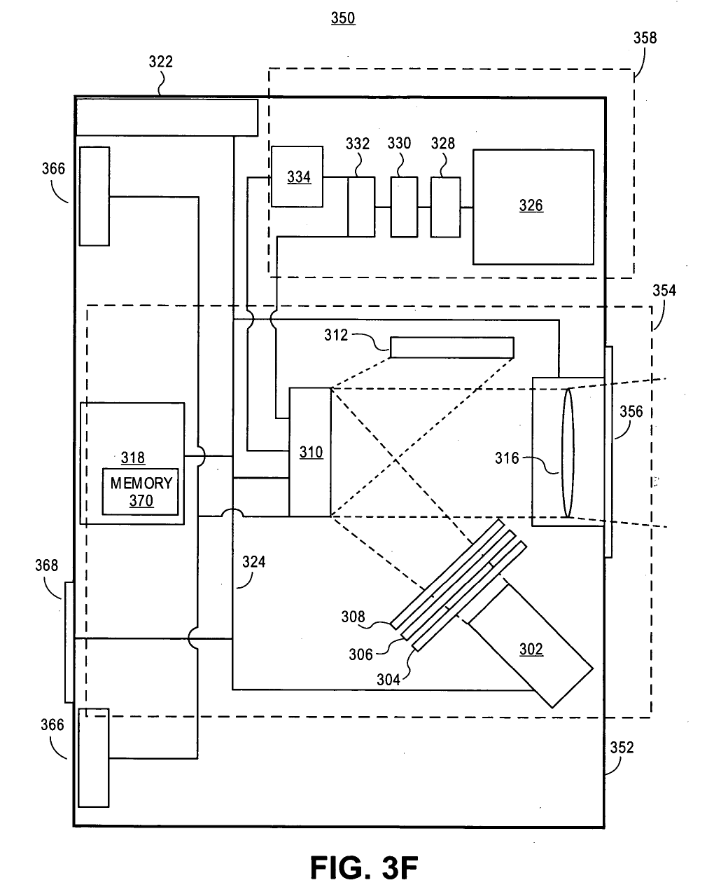

FIG. 3a illustrates some of the components of video projector 104 implemented as an exemplary DLP video projector 354. DLP video projector 354 is an example of one type of projector which may be used with system 100. One skilled in the art will understand that any type of video projector may be used with system 100, such as a CRT projector or an LCD projector.

DLP video projector 354 may include a controller 318 and a bus 324. Controller 318 may include components to control and monitor DLP video projector 354. For example, controller 318 may include a processor, non-volatile memory, volatile memory, and mass storage, such as a hard disk. All the components of DLP video projector 354 may be coupled via bus 324 to allow all the components to communicate with controller 318 and one another. DLP video projector 354 includes a fan 322 to cool DLP video projector 300. Fan 322 may also be coupled to bus 324. DLP video projector 354 also includes a power supply (not shown) coupled to all the components.

DLP video projector 354 contains a light source 302 for generating light to produce a video image. Light source 302 may be, for example, an ultra-high performance (“UHP”) lamp capable of producing from 50-500 wafts of power. Light source 302 may be coupled to bus 324 to communicate with other components. For example, controller 318 or DLP circuit board 310 may control the brightness of light source 302.

Light generated by light source 302 passes though optics 304, 308 and color filter 306. Optics 304 and 308 may be, for example, an anamorphic lens, a condenser and a shaper, respectively, for manipulating the light generated by light source 302. Color filter 306 may be, for example, a color wheel capable of spinning at various speeds to produce various colors.

Video projector 104 also contains a DLP circuit board 310. DLP circuit board 310 may include a digital micro-mirror device, a processor, and memory. For example, DLP circuit board 310 may be a DARKCHIP2 or DARKCHIP3 DLP chip manufactured by TEXAS INSTRUMENTS. DLP circuit board 310 is coupled to bus 324 to receive the video signal received from input/output ports 320 (such as those shown in FIG. 2) and to communicate with controller 318. DLP circuit board 310 reflects light from light source 302 using digital micro-mirrors and generates video based on the video signal to be displayed on video screen 102. DLP circuit board 310 reflects light not used for the video onto light absorber 312. Light reflected by DLP circuit board 310 used for the video passes through lens housing 314 and lens 316. Lens 316 focuses the video to be displayed on display screen 102. Lens housing 314 may include a manual lens moving mechanism or a motor to automatically move or focus lens 316. The manual lens moving mechanism or motor controls the position of lens 316 and, as a result, may shift the position of the video displayed on display screen 102. The shifting may be achieved by moving lens 316 in any combination of the x, y, or z directions.

As noted, DLP video projector 102 includes input/output ports 320. Input/output ports 320 may be a single port or multiple ports, such as those shown in FIG. 2. Input/output ports 320 enables DLP video projector to receive video signals, receive signals from a remote control device, and output signals to other sources. For example, input/output ports 320 may include ports as illustrated in FIG. 2 or any number of a S-video input, S-video output, composite video input, composite video output, component video input, component video output, DVI-I video input, DVI-I video output, coaxial video input, coaxial video output, audio input, audio output, infrared input, infrared output, RS-232 input, RS-232 output, VGA input, or VGA output. One skilled in the art will realize that the preceding list of input and output ports is exemplary and that input/output ports 320 may include any port capable of sending or receiving an electrical signal. Input/output ports 320 are coupled to bus 324. Signals input into DLP video projector 354 may then be transferred to the various components of DLP video projector 354 via bus 324. Likewise, signals output of DLP video projector 300 may be transferred to input/output ports 320 via bus 324.

As stated above, video source 106 may be integrated with video projector 104. FIGS. 3b-f are various views of a video projection system 350 which includes a video source and video projector integrated into a single housing 352 consistent with some aspects of the present invention. For example, one example of an integrated video projector 104 and video source 106 is shown as video projection system 350 in FIGS. 3b-f. FIG. 3b is a top view of video projection system 350 consistent with aspects of the present invention. As shown in FIG. 3b, video projection system 350 includes video projector 104 and a video source 106 in a single housing 352. For example, video projector 104 may be a DLP projector and video source 106 may be implemented as a DVD player. Video projection system 350 is further shown with a lens housing 356 located in a front portion housing 352. Lens housing 356 may include various lenses, such as an anamorphic lens, used in projecting video onto a display screen. Further, housing 352 may include a tray 360 for housing media read by video source 104. For example, if system 350 is a DVD player, then tray 360 may house DVD discs.

Video projection system 350 also includes projector controls 362 and video source controls 364. For example, projector controls 362 may be a power switch, zoom controls, input/output select controls, and picture mode controls. Video source controls 364 may be tray open/close controls, play/stop controls, and video search controls for operating video source 106. Video projection system 350 may also be controlled by a remote device (not shown). For example, a remote device may include redundant projector controls 362 and video source controls 364. Video projection system 350 also includes speakers 366 for presenting sounds corresponding to video generated by video projection system 350.

FIG. 3c is a front view of video projection system 350. As shown in FIG. 3c, lens housing 356 is located in the front portion of housing 352 of video projection system 350. Further, video source 358 and tray 360 may be housed in the top portion of housing 352 of projection system 350. FIG. 3d is another front view of video projection system 350. FIG. 3d illustrates video projection system 350 when tray 360 is open for inserting media to be played by video source 358.

FIG. 3e is a rear view of video projection system 350. As illustrated in FIG. 3e, an input/output port area may be located in a rear portion of housing 352 of video projection system 350. One example of the configuration of input/output ports is shown in FIG. 3e. For example, input/output port area 368 may include an S-video input 370, DVI-I input 372, component video input 374, VGA input 376, composite video input 378, RS-232 port 380, audio input 382, audio output 384, and optical audio output 386, and power input 388. Input/output port area 368 may include additional input and output ports (not shown). For example, input/output port area 368 may include ports any number of a S-video input, S-video output, composite video input, composite video output, component video input, component video output, DVI-I video input, DVI-I video output, coaxial video input, coaxial video output, audio input, audio output, infrared input, infrared output, RS-232 input, RS-232 output, VGA input, or VGA output. One skilled in the art will realize that the preceding list of input and output ports is exemplary and that input/output port area 368 may include any port capable of sending or receiving an electrical signal.

Further, as illustrated in FIG. 3e, speakers 366 are located in the sides of the rear portion of housing 352 of video projection system 350. Of course, speakers 366 may also be located in other portions of housing 352. In addition, video projection system 350 may be coupled to other speakers (not shown) that are external to housing 352.

FIG. 3f is a block diagram illustrating the internal components of video projection system 350 consistent with aspects of the present invention. As shown, video projection system 350 includes a DLP video projector 354 and a DVD player 358 integrated into single housing 352. One skilled in the art will recognize that a DLP video projector is just one example of projectors that may be used in video projection system 350. One skilled in the art would understand that any type of video projector may be used with video projection system 350 such as a CRT projector or an LCD projector. Further, DVD player 358 is an example of one type of video source which may be used with video projection system 350. One skilled in the art will understand that any type of video source may be used with video projection system 350.

Similar to the example shown in FIG. 3a, DLP video projector 354 may include controller 318 and bus 324. Controller 318 may include components to control and monitor DLP video projector 354. The components of DLP video projector 354 may be coupled to bus 324 to allow all the components to communicate with controller 318 and one another. DLP video projector 354 includes fan 322 to cool DLP video projector 354. Fan 322 may be coupled to bus 324. DLP video projector 354 also includes a power supply (not shown) coupled to all the components.

DLP video projector 354 contains a light source 302 for generating light to produce a video image. Light source 302 may be, for example, an UHP lamp capable of producing from 50-500 watts of power. Light source 300 may be coupled to bus 324 to communicate with other component. For example, controller 318 or DLP circuit board 310 may control the brightness of light source 302.

Light generated by light source 302 passes though optics 304, 308 and color filter 306. Optics 304 and 308 may be, for example, a condenser and a shaper, respectively, for manipulating the light generated by light source 302. Color filter 306 may be, for example, a color wheel capable of spinning at various speeds to produce various colors.

DLP video projector 354 also contains a DLP circuit board 310. DLP circuit board 310 may include a digital micro-mirror device, a processor, and memory. For example, DLP circuit board 310 may be a DARKCHIP2 or DARKCHIP3 DLP chip manufactured by TEXAS INSTRUMENTS. DLP circuit board 310 is coupled to bus 324 to receive the video signal received from input/output ports 320 and to communicate with controller 318. DLP circuit board 310 reflects light from light source 302 using the digital micro-mirrors and generates video based on the video signal to be displayed on display screen 102. DLP circuit board 310 reflects light not used for the video onto light absorber 312. Light reflected by DLP circuit board 310 used for the video passes through lens housing 356 and lens 316. Lens 316 focuses the video to be displayed on display screen 102. Lens housing 356 may include a manual lens moving mechanism or a motor to automatically move lens 316. The manual lens moving mechanism or motor allows the position of lens 316 and, as a result, shift the position of the video displayed on display screen 102. The shifting may be achieved by moving lens 316 in any combination of the x, y, or z directions.

DLP video projector 354 also includes input/output ports 368. Input/output ports 368 may be a single port or multiple ports. Input/output ports 368 enables DLP video projector 354 to receive video signals, receive signals from a remote control device, and output signals to other sources. For example, input/output ports 368 may include ports as illustrated in FIG. 3e or any number of a S-video input, S-video output, composite video input, composite video output, component video input, component video output, DVI-I video input, DVI-I video output, coaxial video input, coaxial video output, audio input, audio output, infrared input, infrared output, RS-232 input, RS-232 output, VGA input, or VGA output. One skilled in the art will realize that the preceding list of input and output ports is exemplary and that input/output port area 368 may include any port capable of sending or receiving an electrical signal. Input/output port area 368 is coupled to bus 324 and to audio bus 336. Signals input into DLP video projector 354 may be transferred to the various components of DLP video projector 354 via bus 324. Likewise, signals output of DLP video projector 354 may be transferred to input/output port area 368 via bus 324.

DLP video projector 354 also includes DVD player 358. DVD player 358 is composed DVD reader 326. DVD reader 326 may include a spindle motor for turning a DVD disc, a pickup head, and a head amplifier equipped with an equalizer. DVD reader 326 is coupled to a decoder/error correction circuit 328, a content scrambling system 330 for copy protecting DVD contents, a program stream demultiplexer (“PS demultiplexer”) 332.

DVD player reads a DVD disc with DVD reader 326 by emitting laser light from the pickup head in order to irradiate the DVD disc with a predetermined wavelength. The reflected light is converted to an electric signal which is then output to the head amplifier. The head amplifier serves to perform signal amplification, waveform shaping and digitization while decoder/error correction circuit 328 serves to perform 8-16 decoding and error correction. Next, content scrambling system 330 performs mutual authentication of the DVD disc and DVD player 358 in order to confirm the authorization.

When the authorization is successfully finished, PS demultiplexer 332 separates the program stream (“PS”) as read from the DVD disc into sound and video data in the form of packetized elementary streams (“PES”). Audio stream decoder 334 decodes the PES sound stream with sound compression encoding technology in order to output audio signals. For example, audio stream decoder may utilize sound compression formats such as AAC, AC3, and MPEG. DLP circuit board 310 decodes and processes the video PES which would include video, sub-picture, and navigation data. For example, DLP circuit board 310 may utilize video compression formats such as MPEG 2. The decoded sound stream is transferred to DLP circuit board 310 and DLP circuit board 310 synchronizes sounds, which is transferred to speakers 366 via sound bus 336 and video, which is generated by DLP video projector 354.

One skilled in the art will realize that controller 318 may be utilized in combination with DLP circuit board 310 for producing video and sound from DVD player 358. Further, DLP circuit board 310 or controller 318 may perform audio decoding functions similar to the functions as performed by audio stream decoder 334.

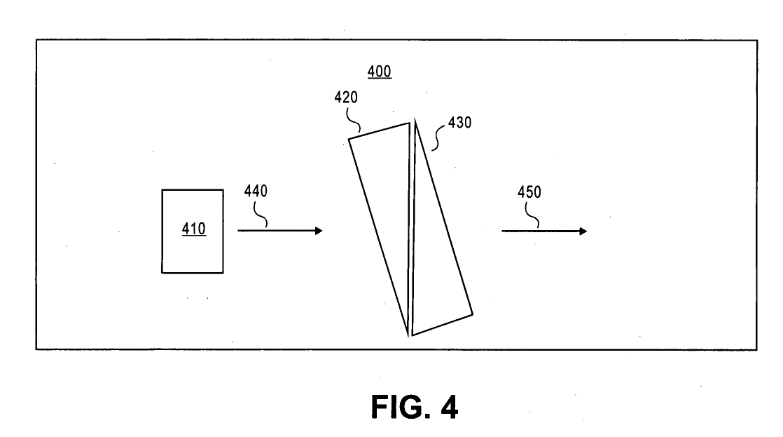

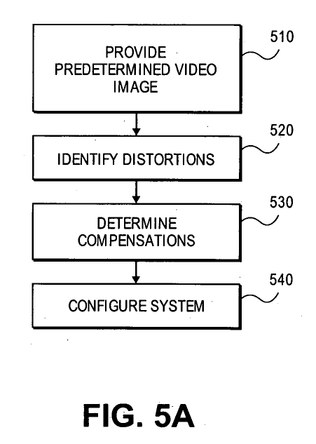

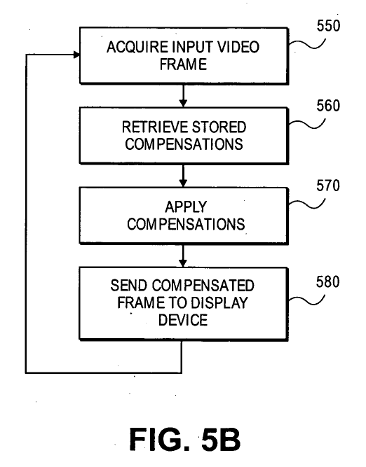

In some embodiments, controller 318 may also comprise a non-volatile memory, such as an EEPROM or the like, to store configuration settings. As will be explained below with reference to FIGS. 4 and 5a-b, these configurations settings may be used to compensate for distortions in the optics of system 350. For example, system 350 may perform geometric compensations for anamorphic lens in its optics. In a typical conversion from the relatively squarish 4:3 aspect ratio to a widescreen 16:9 aspect ration, system 350 needs a lens system that is capable of a horizontal expansion of 133%. In a typical 4:3 video signal, system 350 may project a 1024×768 image. However, if the anamorphic lens can only adequately expand an image 125% horizontally due to distortion, then system 350 may use a geometric scaling, such as scaling of image to 1024×720 in order to achieve a 16:9 aspect ratio image. Other distortions in lens, such as “keystone” effects, can also be compensated similarly in embodiments of the present invention.

One skilled in the art will recognize that the above described features all projection system 350 to use lens that are capable of less than ideal expansion characteristics. For example, system 350 may use anamorphic lens with more negative tolerance. In particular, instead of needing a lens with 133%+−5% expansion tolerance, embodiments of the present invention can use lenses with a tolerance of 133%+0%-10%, while still being able to present an adequate viewing image. Thus, in some embodiments, video projection system 350 may use a cheaper grade lens, such as a lower grade glass or plastic lens to reduce manufacturing costs. Of course, other advantages and features will also be apparent to those skilled in the art. The description below now provides one example of a projection system that compensates for an anamorphic lens.

FIG. 4 illustrates an exemplary anamorphic lens system 400 for use in a video projector, such as video projector 104 or DLP video projector 350. For example, anamorphic lens system 400 may be used in optics 304 or 308 of video projector 104, or in lens 316 of DLP projector system 350. In general, anamorphic lenses provide different magnifications in different orthogonal directions normal to an optical axis. Anamorphic lenses are typically used in projection systems to compress wide-screen images, such as 16:9 aspect ratio images, into more square images, such as 4:3 aspect ratio images. Anamorphic lenses can also be used to expand images in the vertical and horizontal directions.

Anamorphic lens systems can be comprised of a plurality of prisms that act upon a beam image as it passes through each prism. For example, as shown in FIG. 4, anamorphic lens system 400 may utilize two prisms. Lens system 400 receives a source signal 410 (for example, from video source 106 or light source 302), a first anamorphic prism 420, and a second anamorphic prism 430. Source signal 410 is directed as a beam image 440 that can be acted upon by anamorphic prism 420 and anamorphic prism 430 to create a resultant beam image 450.

When anamorphic prism 420 acts upon beam image 440, beam image 440 can be expanded or compressed in either the horizontal or vertical direction. Beam image 440 is also redirected by anamorphic prism 420. Anamorphic prism 430 can redirect the beam image leaving anamorphic prism 420, such that beam image 450 is a compressed or expanded beam image without redirection relative to beam image 440.

Anamorphic prisms 420 and 430 can be made of materials such as optical grade glass or acrylic/plastic. Differing materials can introduce differing distortions and imperfections into the projected image. For example, optical grade glass can introduce ±1% distortion and acrylic/plastic can introduce ±5%. Accordingly, optical grade anamorphic lenses are typically significantly more expensive than acrylic/plastic anamorphic lenses.

FIG. 5a illustrates an exemplary method of calibrating a projection system for the distortions introduced by anamorphic lenses. This method can be manual, or automated. In addition, anamorphic lens may have similar geometric characteristics, and thus, may be pre-sorted into groups. Various systems may be pre-configured with an initial set of compensations so that the initial compensation value is already close to what is expected from a group of anamorphic lenses.

For purposes of explanation, the method shown in FIGS. 5a and 5b are explained with reference to the video projection system shown in FIGS. 3a-f. In stage 510, projection system 350 may display a predetermined video input image. This input image may be provided from a calibration DVD or retrieved from controller 318, for example, from its non-volatile memory or mass storage. For example, in FIG. 3f, controller 318 is shown with a non-volatile memory 370, which may be configured to hold this information. In stage 520, distortions may be identified in the projected image, for example, on display screen 106 by comparing the predetermined image with the projected image.

In stage 530, sets of compensations are determined to compensate for the identified distortions. For example, if anamorphic lens system 400 can only expand a 4:3 aspect ratio image by 125% (rather than the ideal 133%), then system 350 may use a geometric scaling, such as scaling of image to 1024×720 in order to achieve a 16:9 aspect ratio image. Accordingly, controller 318 may modify the output of video source 106 consistent with the compensations.

In stage 540, projection system 350 is configured with the compensations. The compensations may be stored in memory 370. As noted, memory 370 can be a nonvolatile memory such as a ROM, EEPROM, flash memory, SDRAM, NVRAM, magnetic storage device or other nonvolatile memory device. The operation of system 350 will now be described with these compensations in effect.

FIG. 5b illustrates an exemplary method of applying the stored compensations to an input video signal. In stage 550, system acquires a video frame from a video input signal, such as from video source 106. In stage 560, controller 318 then retrieves compensations stored in memory 370. In stage 570, controller 318 applies the compensations to the acquired video input frame. In stage 580, controller 318 transmits the compensated video frame via bus 324 to light source 302 for generating a displayed image. This processing is then repeated and performed in real-time as continuous video frames are input into the projection system 350.

Other aspects of the present invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of correcting video distortion in a projection system, said method comprising:
projecting an image onto a viewing screen that is based on a predetermined image;
identifying distortions present in the projected image;
determining a set of corrections that compensate for the identified distortions; and
configuring the projection system based on the set of corrections.

2. The method of claim 1, wherein the distortions present in the image are due to at least one anamorphic lens in the projection system.

3. The method of claim 2, wherein the at least one anamorphic lens is comprised of optical grade glass.

4. The method of claim 2, wherein the at least one anamorphic lens is comprised of an acrylic or plastic material.

5. The method of claim 1, wherein the distortions are the result of imperfections in the optical components of the projection system.

6. The method of claim 1, the method further comprising, storing the set of corrections in a memory device.

7. The method of claim 6, wherein the memory device is a ROM, EEPROM, flash memory, SDRAM, NVRAM, magnetic storage device or other nonvolatile memory device.

8. The method of claim 1, wherein the method further comprises:
determining the coordinates of the pixels located within the distorted areas of the projected image;
determining the effect on color and brightness of the distorted pixels when compared to the predetermined image.

9. The method of claim 1, wherein configuring the projection system based on the set of corrections comprises:
acquiring a frame of video from an input video signal;
retrieving the set of compensations from a non-volatile memory device;
applying the compensations to the acquired input video frame;
sending the compensated video frame to a video displaying device within the projection system.

10. The method of claim 9, wherein the method continuously corrects video frames in real-time.

11. A system for displaying video, comprising:
an input configured to receive a video signal;
a set of lenses comprising at least one anamorphic lens that is configured to project the video signal;
a memory device configured to store a set of compensations for distortions present in the at least one anamorphic lens; and
a processor configured to modify the video signal based on the stored set of compensations.

12. The system of claim 11, wherein the at least one anamorphic lens is comprised of optical grade glass.

13. The system of claim 11, wherein the at least one anamorphic lens is comprised of an acrylic or plastic material.

14. The system of claim 11, wherein the memory device is a ROM, EEPROM, flash memory, SDRAM, NVRAM, magnetic storage device or other nonvolatile memory device.
